(19) United States
(12) Patent Application Publication
(10) Pub. No.: US 2005/0025869 A1
(43) Pub. Date: Feb. 3, 2005

(54) Cylindrical rolled up snack chip product, method of making and using

(76) Inventors: Benny E. Steffens, Imperial, CA (US); Kayla J. Steffens, Imperial, CA (US)

Correspondence Address: ANTHONY EDW. J CAMPBELL, PO BOX 160370, AUSTIN, TX, 78716, US

(21) Appl. No.: 10/630,383

(22) Filed: Jul. 30, 2003

(51) Int. Cl. A21D 6/00

(52) U.S. Cl. 426/496

(57) ABSTRACT

A cylindrical rolled up snack chip product, method of making and using the product is disclosed. The product is made from the method of making the product comprising the steps of flattening, cooking, cooling, making, removing, and rolling. The making step comprises making a dough by adding together a portion of flour, a portion of oil and a portion of salt. The flattening step comprises flattening a portion of the dough into a flattened pad. The removing step comprises removing a portion of the flattened pad. The rolling step comprises rolling up the removed portion of the flattened pad to produce a precooked rolled chip. The cooking step comprises cooking the precooked rolled chip to produce a cooked rolled chip. The cooling step comprises cooling the cooked rolled chip to produce the cylindrical snack chip product. The method of using the product comprises the steps of biting, chewing, dipping, inserting, lifting, obtaining, picking, swallowing, and swirling.

### FIELD OF THE INVENTION

The present invention relates snack food product, more particularly, a cylindrical rolled up snack chip product by process of making, and an associated method of using the product.

### DESCRIPTION OF THE PRIOR ART

Commercially available snack chip products, such as corn chips, potato chips, and alike enjoy an incredible commercial success yet these products suffer from the tendency in being easily broken as well as not delivering a sufficiently hearty portion to the consumer. Therefore a need exist for a chip product which is less likely to break as well as capable of delivering heartier portions to the consumer.

A wide variety of food items is currently available on the commercial market and an even larger number of these types of products are known in the art of food production and storage, for example, the beef product for cooking on a vertical rotisserie disclosed by Coroneos in U.S. Pat. No. 4,393,090; the method of browning food in a microwave oven disclosed by Eck and Buck in U.S. Pat. No. 4,396,817; the sauce and gravy compositions disclosed by Gonteneau and Germon in U.S. Pat. No. 4,597,974; the shaped pasta products disclosed by Molinari in U.S. Pat. No. 4,693,900; the sweet and sour garlic sauce disclosed by Vella in U.S. Pat. No. 4,935,259; the milk preparations disclosed by Laufer in U.S. Pat. No. 5,106,643; the process for making pepper kraut disclosed by Bastian et al. in U.S. Pat. No. 5,258,198; the fruit spread and method of preparing same disclosed by Brain et al. in U.S. Pat. No. 5,260,083; the frozen desserts with flavor strands disclosed by Kortschot in U.S. Pat. No. 5,356,648; the food container disclosed by Seppala in U.S. Pat. No. D339,744; and the snack food disclosed by Thorniley et al. in U.S. Pat. No. D343,494.

While all of the above-described products fulfill their respective, particular objectives and requirements, the aforementioned patents do not describe a product having a cylindrical rolled up shape in a snack chip product made by the process of flattening, cooking, cooling, making, removing, and rolling. This combination of elements would specifically match the user's particular individual needs of making it possible to provide a heartier chip product being less likely to break than standard commercially available chip products. The above-described patents make no provision for a product having a cylindrical rolled up shape in a snack chip product made by the process of flattening, cooking, cooling, making, removing, and rolling.

Therefore, a need exists for a new and improved cylindrical rolled up snack chip product having a cylindrical rolled up shape in a snack chip product made by the process of flattening, cooking, cooling, making, removing, and rolling. In this respect, the cylindrical rolled up snack chip product according to the present invention substantially departs from the conventional concepts and designs of the prior art, and in doing so provides an apparatus primarily developed for the purpose of providing a means for providing a heartier chip product which is less likely to break than standard commercially available chip products.

### SUMMARY OF THE INVENTION

The present product, methods of making of using, according to the principles of the present invention, overcomes the shortcomings of the prior art by providing a cylindrical rolled up snack chip product, and methods of making and using are disclosed. The product is made from the method of making the product comprising the steps of flattening, cooking, cooling, making, removing, and rolling. The making step comprises making a dough by adding together a portion of flour, a portion of oil and a portion of salt. The flattening step comprises flattening a portion of the dough into a flattened pad. The removing step comprises removing a portion of the flattened pad. The rolling step comprises rolling up the removed portion of the flattened pad to produce a precooked rolled chip. The cooking step comprises cooking the precooked rolled chip to produce a cooked rolled chip. The cooling step comprises cooling the cooked rolled chip to produce the cylindrical snack chip product. The method of using the product comprises the steps of biting, chewing, dipping, inserting, lifting, obtaining, picking, swallowing, and swirling.

In view of the foregoing disadvantages inherent in the known type products by process now present in the prior art, the present invention provides an improved cylindrical rolled up snack chip product, which will be described subsequently in great detail, is to provide a new and improved cylindrical rolled up snack chip product which is not anticipated, rendered obvious, suggested, or even implied by the prior art, either alone or in any combination thereof.

To attain this, the present invention essentially comprises the product is made from the method of making the product comprising the steps of flattening, cooking, cooling, making, removing, and rolling. The making step comprises making a dough by adding together a portion of flour, a portion of oil and a portion of salt. The flattening step comprises flattening a portion of the dough into a flattened pad. The removing step comprises removing a portion of the flattened pad. The rolling step comprises rolling up the removed portion of the flattened pad to produce a precooked rolled chip. The cooking step comprises cooking the precooked rolled chip to produce a cooked rolled chip. The cooling step comprises cooling the cooked rolled chip to produce the cylindrical snack chip product.

There has thus been outlined, rather broadly, the more important features of the invention in order that the detailed description thereof that follows may be better understood, and in order that the present contribution of the art may be better appreciated.

Numerous objects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved cylindrical rolled up snack chip product that has all the advantages of the prior art cylindrical rolled up snack chip product and none of the disadvantages.

It is another object of the present invention to provide a new and improved cylindrical rolled up snack chip product that may be easily and efficiently manufactured and marketed.

An even, further object of the present invention is to provide a new and improved cylindrical rolled up snack chip product that has a low cost of manufacture with regard to both materials and labor, and which accordingly is then susceptible of low prices of sale to the consuming public, thereby making such multipurpose storage unit and system economically available to the buying public.

Still another object of the present invention is to provide a new cylindrical rolled up snack chip product that provides in the apparatuses and methods of the prior art some of the advantages thererof, while simultaneously overcoming some of the disadvantages normally associated therewith.

Even still another object of the present invention is to provide a product having a cylindrical rolled up shape in a snack chip product made by the process of flattening, cooking, cooling, making, removing, and rolling. This combination of elements makes it possible to provide a heartier chip product being less likely to break than standard commercially available chip products.

Still another object of the present invention is to provide a method of making the product comprising the steps of flattening, cooking, cooling, making, removing, and rolling.

Lastly, it is an object of the present invention to provide a new and improved method of using comprising the steps of biting, chewing, dipping, inserting, lifting, obtaining, picking, swallowing, and swirling.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein

FIG. 1 is a perspective view of a preferred embodiment of the cylindrical rolled up snack chip product constructed in accordance with the principles of the present invention;

FIG. 2 is a perspective view of a preferred embodiment of the cylindrical rolled up snack chip product of the present invention;

FIG. 3 is an itemized list of ingredients of a preferred embodiment of the cylindrical rolled up snack chip product of the present invention;

FIG. 4 is an itemized list of ingredients of a preferred embodiment of the cylindrical rolled up snack chip product of the present invention; and

FIG. 5 an itemized list of ingredients of a view of a preferred embodiment of the cylindrical rolled up snack chip product of the present invention.

The same reference numerals refer to the same parts throughout the various figures.

### DETAILED DESCRIPTION OF THE PREFERRED EMBODIMENT

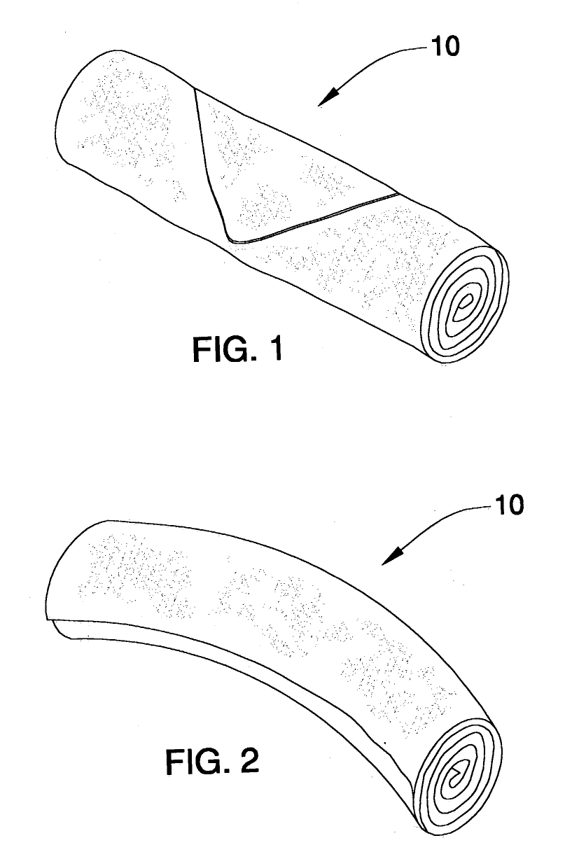

Referring now to the drawings, and in particular FIG. 1 to 5 thereof, one preferred embodiment of the present invention is shown and generally designated by the reference numeral 10. One preferred embodiment of a cylindrical rolled up snack chip product 10 made by the process comprises: producing a dough by adding together a portion of flour, a portion of oil and a portion of salt; flattening a portion of the dough into a flattened pad; removing a portion of the flattened pad; rolling up the removed portion of the flattened pad to produce a precooked rolled chip; cooking the precooked rolled chip to produce a cooked rolled chip; and cooling the cooked rolled chip to produce the product 10.

One preferred embodiment of a method of making a cylindrical rolled up snack chip product 10, the method comprising the steps of flattening, cooking, cooling, making, removing, and rolling. The making step comprises making a dough by adding together a portion of flour, a portion of oil and a portion of salt. The flattening step comprises flattening a portion of the dough into a flattened pad. The removing step comprises removing a portion of the flattened pad. The rolling step comprises rolling up the removed portion of the flattened pad to produce a precooked rolled chip. The cooking step comprises cooking the precooked rolled chip to produce a cooked rolled chip. The cooling step comprises cooling the cooked rolled chip to produce the cylindrical snack chip product 10.

The proportion of the flour, oil and salt may be any commercially known proportions. One preferred configuration is that the portion of flour comprising fifty to ninety percent of the total weight of the dough, the portion of oil comprising ten to fifty percent of the total weight of the dough, and the portion of salt comprising one to ten percent of the total weight of the dough. A more preferred configuration of the proportions comprises the portion of flour comprises about eighty percent of the total weight of the dough, the portion of oil comprising about seventeen percent of the total weight of the dough, and the portion of salt comprising about three percent of the total weight of the dough.

The producing step may further comprises adding a portion of seasoning into the dough, in which the seasoning may be selected from the group consisting of onion powder, dehydrated onion pieces, garlic powder, dehydrated garlic pieces, pepper seeds, pepper pieces, barbecue sauce flavoring and cheese. The producing step may also further comprises adding a portion of sodium bicarbonate, a portion of yeast, a portion of malted barley flour and a portion of enzymes into the dough.

The cooking step may comprise any commercially known manner of cooking, in which a preferred modes of cooking may be selected from the group consisting of frying, baking, and drying.

The oil may comprises any commercially edible oil, in which a preferred selection of oil may be selected from the group consisting of corn oil, cottonseed oil, sunflower oil, partially hydrogenated soybean oil, and partially hydrogenated vegetable oil shortening containing soybean oil and cottonseed oil.

The flour may comprise any commercially known edible flour, in which a preferred selection of flour may be selected from the group consisting of corn flour, potato flour, and enriched wheat flour wherein the enriched wheat flour comprising wheat flour, niacin, reduced iron, thiamin mononitrate, riboflavin and folic acid.

One preferred embodiment of a method of using the cylindrical rolled up snack chip product 10, the method of using comprising the steps of biting, chewing, dipping, inserting, lifting, obtaining, picking, swallowing, and swirling. The obtaining step comprises obtaining the product 10 made by the process comprising: producing a dough by adding together a portion of flour, a portion of oil and a portion of salt, wherein the portion of flour comprising about eighty percent of the total weight of the dough, the portion of oil comprising about seventeen percent of the total weight of the dough, and the portion of salt comprising about three percent of the total weight of the dough; flattening a portion of the dough into a flattened pad; removing a portion of the flattened pad; rolling up the removed portion of the flattened pad to produce a precooked rolled chip; cooking the precooked rolled chip to produce a cooked rolled chip; and cooling the cooked rolled chip to produce the product 10. The picking step comprises picking up the product 10. The dipping step comprises dipping one end of the product 10 into a salsa sauce. The swirling step comprises swirling around the one end of the product 10 dipped into the salsa sauce so that a portion of the salsa sauce adheres to the one end of the product 10. The lifting step comprises lifting up a portion of the salsa sauce adhering onto the one end of the product 10. The inserting step comprises inserting the one end of the product 10 having the portion of salsa sauce adhering onto the one end of the product 10 into a mouth. The biting step comprises biting off the one end of the product 10 having the portion of salsa sauce adhering onto the one end of the product 10 when the one end of the product 10 is inserted into the mouth. The chewing step comprises chewing up the bitten off one end of the product 10. The swallowing step comprises swallowing the chewed up bitten off one end of the product 10.

Referring now to FIG. 1 and FIG. 2 which depict a perspective views of an preferred embodiment of the cylindrical rolled up snack chip product 10 showing the product 10 may be substantially straight or bent.

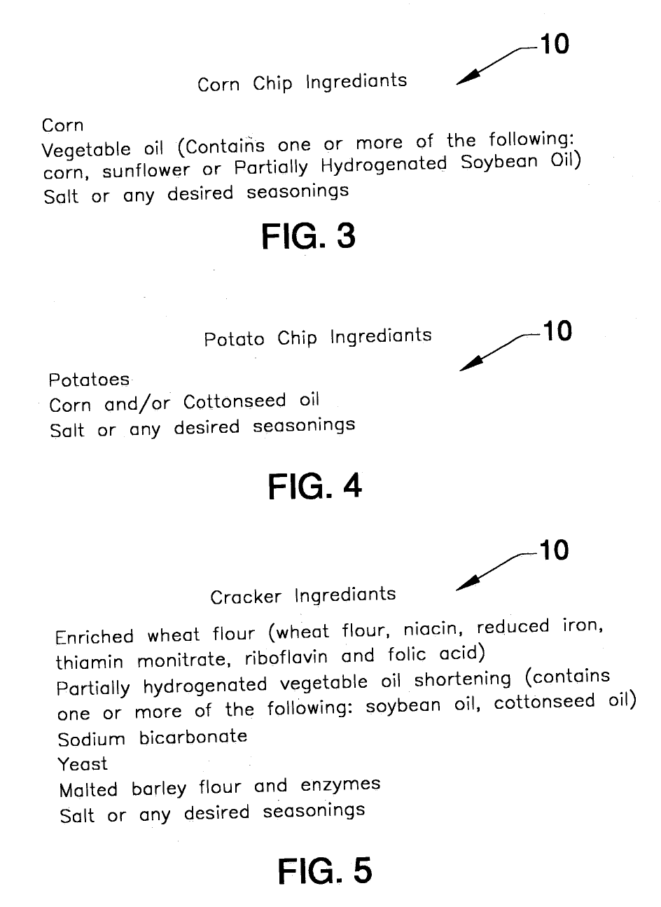

Refer now to FIG. 3, which depicts an itemized list of ingredients of a preferred embodiment of the cylindrical rolled up snack chip product 10 showing that the product may be made into a corn chip product.

Refer now to FIG. 4, which depicts an itemized list of ingredients of a preferred embodiment of the cylindrical rolled up snack chip product 10 showing that the product may be made into a potato chip product.

Refer now to FIG. 5, which depicts an itemized list of ingredients of a view of a preferred embodiment of the cylindrical rolled up snack chip product 10 showing that the product 10 may be made into a cracker product.

As to the manner of usage and operation of the present invention, the same should be apparent from the above description. Accordingly, no further discussion relating to the manner of usage and operation will be provided.

While a preferred embodiment of the cylindrical rolled up snack chip product has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations, thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of making a cylindrical rolled up snack chip product, said method comprising the steps of
making a dough by adding together a portion of flour, a portion of oil and a portion of salt;
flattening a portion of the dough into a flattened pad;
removing a portion of the flattened pad;
rolling up the removed portion of the flattened pad to produce a precooked rolled chip;
cooking the precooked rolled chip to produce a cooked rolled chip; and
cooling the cooked rolled chip to produce the cylindrical snack chip product.

2. The method of claim 1 wherein said portion of flour comprising fifty to ninety percent of the total weight of said dough, said portion of oil comprising ten to fifty percent of the total weight of said dough, and said portion of salt comprising one to ten percent of the total weight of said dough.

3. The method of claim 2 wherein said portion of flour comprising about eighty percent of the total weight of said dough, said portion of oil comprising about seventeen percent of the total weight of said dough, and said portion of salt comprising about three percent of the total weight of said dough.

4. The method of claim 1 wherein said producing step further comprises adding a portion of seasoning into the dough.

5. The method of claim 4 wherein said seasoning is selected from the group consisting of onion powder, dehydrated onion pieces, garlic powder, dehydrated garlic pieces, pepper seeds, pepper pieces, barbecue sauce flavoring and cheese.

6. The method of claim 1 wherein said producing step further comprises adding a a portion of sodium bicarbonate, a portion of yeast, a portion of malted barley flour and a portion of enzymes into the dough.

7. The method of claim 1 wherein said cooking is selected from the group consisting of frying, baking, and drying.

8. The method of claim 1 wherein said oil is selected from the group consisting of corn oil, cottonseed oil, sunflower oil, partially hydrogenated soybean oil, and partially hydrogenated vegetable oil shortening containing soybean oil and cottonseed oil.

9. The method of claim 1 wherein said flour is selected from the group consisting of corn flour, potato flour, and enriched wheat flour.

10. The method of claim 6 wherein the enriched wheat flour comprising wheat flour, niacin, reduced iron, thiamin mononitrate, riboflavin and folic acid.

11. A cylindrical rolled up snack chip product made by the process comprising:
producing a dough by adding together a portion of flour, a portion of oil and a portion of salt;
flattening a portion of the dough into a flattened pad;
removing a portion of the flattened pad;
rolling up the removed portion of the flattened pad to produce a precooked rolled chip;
cooking the precooked rolled chip to produce a cooked rolled chip; and
cooling the cooked rolled chip to produce the product.

12. The product of claim 11 wherein said producing step further comprises adding a portion of seasoning into the dough.

13. The product of claim 11 wherein said producing step further comprises adding a portion of seasoning into the dough.

14. The product of claim 13 wherein said seasoning is selected from the group consisting of onion powder, dehydrated onion pieces, garlic powder, dehydrated garlic pieces, pepper seeds, pepper pieces, barbecue sauce flavoring and cheese.

15. The product of claim 11 wherein said producing step further comprises adding a a portion of sodium bicarbonate, a portion of yeast, a portion of malted barley flour and a portion of enzymes into the dough.

16. The product of claim 11 wherein said cooking is selected from the group consisting of frying, baking, and drying.

17. The product of claim 11 wherein said oil is selected from the group consisting of corn oil, cottonseed oil, sunflower oil, partially hydrogenated soybean oil, and partially hydrogenated vegetable oil shortening containing soybean oil and cottonseed oil.

18. The product of claim 11 wherein said flour is selected from the group consisting of corn flour, potato flour, and enriched wheat flour.

19. The product of claim 18 wherein the enriched wheat flour comprising wheat flour, niacin, reduced iron, thiamin mononitrate, riboflavin and folic acid.

20. A method of using a cylindrical rolled up snack chip product, said method of using comprising the steps of:
obtaining the product made by the process comprising:
producing a dough by adding together a portion of flour, a portion of oil and a portion of salt, wherein said portion of flour comprising about eighty percent of the total weight of said dough, said portion of oil comprising about seventeen percent of the total weight of said dough, and said portion of salt comprising about three percent of the total weight of said dough;
flattening a portion of the dough into a flattened pad;
removing a portion of the flattened pad;
rolling up the removed portion of the flattened pad to produce a precooked rolled chip;
cooking the precooked rolled chip to produce a cooked rolled chip; and
cooling the cooked rolled chip to produce the product;
picking up the product;
dipping one end of the product into a salsa sauce;
swirling around the one end of the product dipped into the salsa sauce so that a portion of the salsa sauce adheres to the one end of the product;
lifting up a portion of the salsa sauce adhering onto the one end of the product;
inserting the one end of the product having the portion of salsa sauce adhering onto the one end of the product into a mouth;
biting off the one end of the product having the portion of salsa sauce adhering onto the one end of the product when the one end of the product is inserted into the mouth.
chewing up the bitten off one end of the product; and
swallowing the chewed up bitten off one end of the product.
